(19) United States
(12) Patent Application Publication
(10) Pub. No.: US 2018/0318645 A1
(43) Pub. Date: Nov. 8, 2018

(54) METHOD AND APPARATUS FOR CONTROLLING MOBILE TERMINAL LINKED TO WEARABLE DEVICE

(71) Applicant: GREENCOMM CO., LTD., Anyang-si (KR)

(72) Inventor: Ki Chul SHIN, Gunpo-si (KR)

(21) Appl. No.: 15/771,679

(22) PCT Filed: Oct. 27, 2016
(86) PCT No.: PCT/KR2016/012169

§ 371 Date: Apr. 27, 2018

(30) Foreign Application Priority Data
Oct. 28, 2015 (KR) 10-2015-0150454

(51) Int. Cl. A63B 24/00; G06K 9/00; G06F 1/16

(52) U.S. Cl. CPC A63B 24/0075; A63B 24/0062; A63B 2024/0068; G06F 1/163; A63B 2024/0071; G06K 9/00342

(57) ABSTRACT

A method for controlling mobile terminal communicating wearable device is provided. The method comprises: displaying by recommending a plurality of types of exercises, a recommendable intensity performed by each exercise and a recommendable time performed by each exercise in response to the target consumable calorie, and displaying an intensity of exercise currently being performed and displaying a ratio of the recommendable intensity of exercise to an intensity of exercise currently being performed by the user, by receiving a user exercise data received from the wearable device.

### FIELD OF THE DISCLOSURE

The teachings in accordance with exemplary embodiments of this disclosure generally relate to a method and apparatus for controlling mobile terminal communicating wearable device.

### DESCRIPTION OF RELATED ART

This section provides background information related to the present disclosure which is not necessarily prior art.

Modern people suffer from adult diseases such as imbalance of posture and obesity due to lack of physical activities and irregular eating habits. As a result, interest in health and exercise has increased, and various sporting goods or sports system have been developed.

Meantime, various wearable devices that are worn by users to check health are recently disclosed, and these wearable devices can check an amount of exercise of a user in association with sports systems and the amount of exercise is notified to a user terminal that is interacted wirelessly.

However, the conventional wearable devices suffer from disadvantages in that a user inputs in advance the type of exercise to a wearable device before starting an exercise, and calculates a consumed calorie by checking a moved distance through a GPS (Global Positioning System), and as a result, discomfort may be generated because a user must recognize and input an exercise to be performed whereby it is difficult to accurately calculate a consumed calorie.

Furthermore, there is generated a difficult problem in calculating how long and what type of exercise to perform and at what intensity, in order to consume desired calorie consumption.

### Technical Problem

The technical subject to be solved by the present disclosure is to provide a method and apparatus for controlling mobile terminal communicating wearable device capable of recommending an exercise adequate to a target consumable calorie, and providing information to reach the target consumable calorie achievable by a currently performing exercise, including the type of exercise, the intensity of exercise and the time of exercise.

### Technical Solution

In one aspect of the present disclosure, there may be provided a method for controlling mobile terminal communicating wearable device worn at a predetermined place of a body of a user, the method comprising: determining a target consumable calorie by receiving an input of a target consumable calorie to be consumed by a user or by receiving an input relative to a body weight to be reduced; displaying a plurality of types of exercises, a recommendable intensity performed by each exercise and a recommendable time in performing each exercise in response to the target consumable calorie; displaying type and intensity of exercise currently performed by the user by receiving in real time an exercise type data of the user recognized continuously by the wearable device while the user wears the wearable device; and displaying a ratio of the intensity of exercise currently performed by the user to the recommendable intensity of the exercise to, and a time required to consume the target consumable calorie with the intensity of exercise currently performed by the user.

In some exemplary embodiment of the present invention, the displaying type and intensity of exercise step may further include displaying a calorie consumed by the exercise currently performed by the user, along with the target consumable calorie.

In another general aspect of the present invention, there may be an apparatus for controlling mobile terminal communicating wearable device, the apparatus comprising: a display part; and a controller configured to: determine a target consumable calorie by receiving an input of a target consumable calorie to be consumed by a user or by receiving an input relative to a body weight to be reduced, display, on the display part, a plurality of types of exercises, a recommendable intensity performed by each exercise and a recommendable time in performing each exercise in response to the target consumable calorie, display, on the display part, type and intensity of exercise currently performed by the user by receiving in real time an exercise type data of the user recognized continuously by the wearable device while the user wears the wearable device, and display, on the display part, a ratio of the intensity of exercise currently performed by the user to the recommendable intensity of the exercise to, and a time required to consume the target consumable calorie with the intensity of exercise currently performed by the user.

In some exemplary embodiment of the present invention, the controller may further display, on the display part, a calorie consumed by the exercise currently performed by the user, along with the target consumable calorie.

### Advantageous Effects

The present disclosure has an advantageous effect in that the exercise data of a user can be automatically and continuously received from the wearable device to manage the health of the user by controlling a consumed calorie of the user, and to proactively provide a measure against obesity by providing types of exercise to be consumed by the user and consumed calorie, and to recommend an exercise to consume the calorie.

### BRIEF DESCRIPTION OF DRAWINGS

FIG. 1 is an exemplary view illustrating a wearable device worn by a user according to an exemplary embodiment of the present disclosure.

FIG. 2 is a block diagram illustrating a mobile terminal according to an exemplary embodiment of the present disclosure.

FIG. 3 is an exemplary view in which a controller automatically recognizes a user exercise, automatically calculates a consumed calorie in response thereto, and displays the automatic calculation of consumed calorie.

FIG. 4 is an exemplary view in which a controller displays a recommended exercise in response to a target consumable calorie of a user.

### SUMMARY OF DISCLOSURE

In order to fully explain the configuration and effects of the present disclosure, exemplary embodiments of the present disclosure will be explained with reference to the accompanying drawings.

However, the present disclosure is not limited to the embodiments and may be realized in various other forms. The embodiments are only provided to more completely illustrate the present disclosure and to render a person having ordinary skill in the art to fully understand the scope of the present disclosure. The scope of the present disclosure is defined only by the claims. Accordingly

In the drawings, the thicknesses or sizes of respective layers are exaggerated, omitted or schematically illustrated for clarity and convenience of description. Therefore, the sizes of respective elements do not wholly reflect actual sizes thereof.

Furthermore, various aspects of the subject matter disclosed herein are described with reference to a structure or a portion being formed on other structures, portions, or both. As will be appreciated by those of skill in the art, references to a structure being formed “on” or “above” another structure or portion contemplates that additional structure, portion, or both may intervene. References to a structure or a portion being formed “on” another structure or portion without an intervening structure or portion are described herein as being formed “directly on” the structure or portion. Similarly, it will be understood that when an element is referred to as being “connected”, “attached”, or “coupled” to another element, it can be directly connected, attached, or coupled to the other element, or intervening elements may be present. In contrast, when an element is referred to as being “directly connected”, “directly attached”, or “directly coupled” to another element, no intervening elements are present.

Furthermore, the terms “first,” “second,” and the like, herein do not denote any order, quantity, or importance, but rather are used to distinguish one element from another. For example, unless deviated from the scope of right of the present disclosure, ‘a first element’ may be defined as ‘a second element’ and similarly, ‘a second element’ may be also defined as ‘a first element’.

As used herein, the terms “a” and “an” are open terms that may be used in conjunction with singular items or with plural items. It will be further understood that the terms “comprises” and/or “comprising,” “including” and/or “including”, when used in this specification, specify the presence of stated features, regions, integers, steps, operations, elements, and/or components, but do not preclude the presence or addition of one or more other features, regions, integers, steps, operations, elements, components, and/or groups thereof. All ranges and endpoints reciting the same feature are independently combinable.

Unless otherwise defined, all terms including technical and scientific terms used herein have the same meaning as commonly understood by one of ordinary skill in the art to which this invention belongs.

Hereinafter, the exemplary embodiments of the present disclosure will be described in detail with reference to the accompanying drawings.

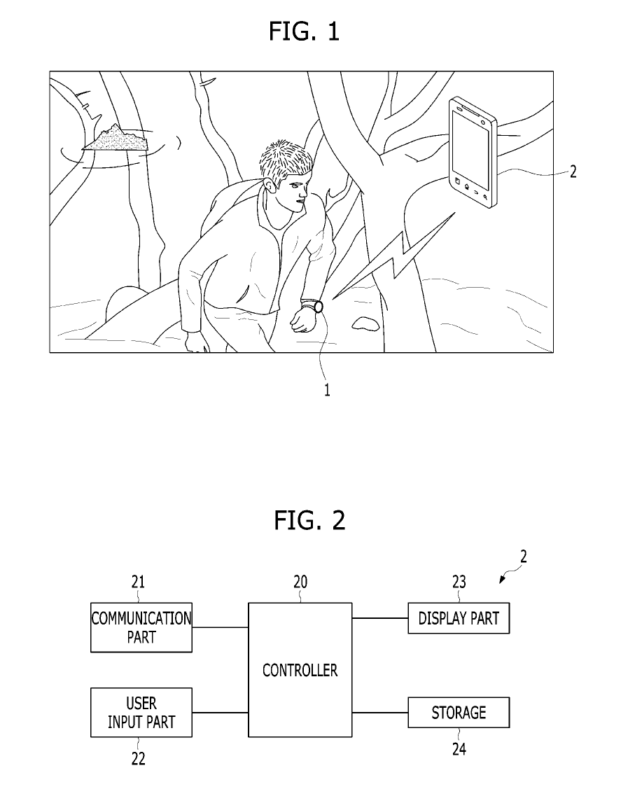

FIG. 1 is an exemplary view illustrating a wearable device worn by a user according to an exemplary embodiment of the present disclosure.

Referring to FIG. 1, a wearable device (1) worn by a user according to an exemplary embodiment of the present disclosure illustrates that a user wears the wearable device (1) on a wrist, for example, where the wearable device (1) may be connected to a mobile terminal (2) held by the user through a communication. However, although the exemplary embodiment of the present disclosure has illustrated that the wearable device (1) is worn on a wrist of a user, it is merely exemplary, and the present disclosure is not limited thereto, and the wearable device (1) may be also worn on various physical areas of body.

The connection between the wearable device (1) and the mobile terminal (2) of a user may be implemented by various methods. For example, the communication may be realized by a near field communication system such as Bluetooth®, an NFC (Near Field Communication), and a Zigbee®, or may be implemented by an RF method, or may be performed by various communication methods such as WiFi, or WiFi Direct. However, the abovementioned communication methods are merely exemplary, and the present disclosure is not limited thereto. The communication may be realized by other various communication methods as the technologies are developed and evolved.

The mobile terminal (2) is held by a user, and may include a movable terminal such as a mobile phone, a smart phone, a pad-type computer and a notebook computer. However, the configuration in the exemplary embodiment described in the specification may be applicable to a fixed terminal such as a digital TV or a desktop computer, unless being applicable only on the mobile terminal.

FIG. 2 is a block diagram illustrating a mobile terminal according to an exemplary embodiment of the present disclosure.

Referring to FIG. 2, the mobile terminal (2) according to the present disclosure may include a controller (20), a communication part (21), a user input part (22), a display part (23) and storage (24). However, the elements illustrated in FIG. 2 are not essential parts, and therefore, more elements or fewer elements than what is illustrated in FIG. 2 may be included in the mobile terminal (2). Elements that have nothing to do with the operation of the present invention will be omitted in the explanation, albeit being generally mounted on the mobile terminal (2).

The communication part (21) may include one or more of modules that enable a communication between the wearable device (1) and the mobile terminal (2). The communication method between the wearable device (1) and the mobile terminal (2) may be performed by various methods as explained above, and the communication part (21) may include a module corresponding to a communication method.

The user input part (22) is a module that generates an input data for operation control of the mobile terminal (2) by a user, and may be formed by any one of a key pad, a dome switch, a touch pad (static pressure/electrostatic), a jog wheel and a jog switch.

The display part (23) may readably and visibly display information processed by the mobile terminal (2), i.e., information processed by control of the controller (20), and may include at least one of an LCD (Liquid Crystal Display), a TFT-LCD (Thin Film Transistor-Liquid Crystal Display), an OLED (Organic Light-Emitting Diode), a flexible display, and a 3D display.

When the display part (23) and a sensor (touch sensor) detecting a touch operation form a mutual layer structure (hereinafter referred as ‘touch screen’), the display part (23) may be also used as a user input part (22), which is an input device, in addition to an output device.

The storage (24) may store an activity-related data received from the wearable device (1), and may also store an application-related data provided from an application providing server (not shown) for the present invention.

The controller (20), in relation to the exemplary embodiment of the present invention, may provide various information including, receiving the types of activities of a user automatically recognized from the wearable device (1) to calculate a consumed calorie, displaying the calculated consumed calorie on the display part (23), recommending an exercise to be performed by a user in order to consume a target consumable calorie, and providing how much and how long a user must continuously perform in order to reach a target consumable calorie in respect to an exercise a user currently performs.

Hereinafter, operations performed between the controller (20) and the wearable device (1) according to the present invention will be described.

The wearable device (1) according to an exemplary embodiment of the present invention may automatically recognize a user activity and analyze the recognized user activity. The wearable device according to the present invention may recognize sleeping behaviors such as the number of tosses and turns, and non-sleeps during sleeps, and recognize stability behaviors such as rest, TV watching and desk works. Furthermore, the wearable device according to the present invention may recognize daily life such as cleaning, dishwashing and driving, and may recognize walking activities regardless of wrist movement. In addition, the wearable device (1) may recognize fast walking and slow running, and may recognize running regardless of being performed indoors and outdoors.

As noted from the foregoing, the wearable device (1) may recognize a total of 14 different types of exercises including indoor/outdoor walking, fast walking, running, stair workout, stability, light activities, sleeping, golf, rope jumping, tennis, ping-pong, mountain-climbing (absolute altitude indicated), indoor/outdoor cycling and walk & run exercise, and provide the relevant data to the mobile terminal (2). However, these activities are merely exemplary, and the present invention is not limited thereto.

These exercise data may be recognized without interruption while the user wears the wearable device (1), and if the user performs an exercise without wearing the wearable device (1), the exercise content may be also provided to the controller (20) through the user input part (22).

The controller (20) having received the user's exercise data through the communication part (21) may calculate the consumed calorie corresponding to the user's exercise data, and may display the data.

That is, the controller (20) may receive a user behavior data from the wearable device (1) while the user activates by wearing the wearable device (1), and may calculate in real time a calorie corresponding to the relevant behavior and store the calculated calorie in the storage (24).

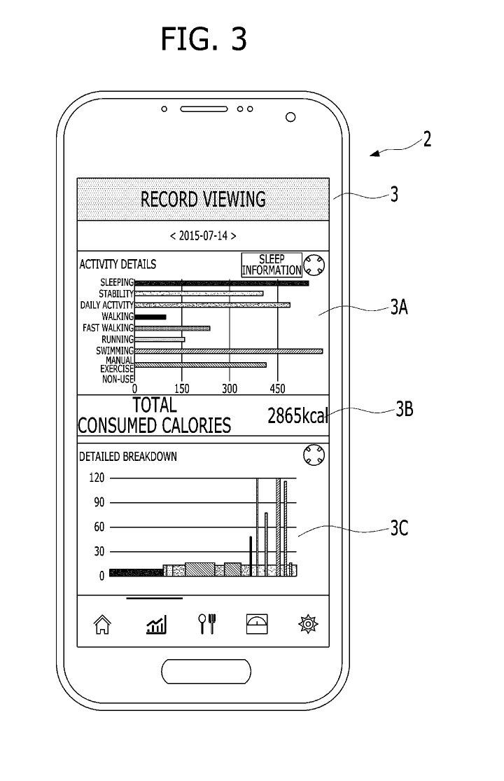

FIG. 3 is an exemplary view in which a controller (20) automatically recognizes a user exercise, automatically calculates a consumed calorie in response thereto, and displays the automatic calculation of consumed calorie.

Referring to FIG. 3, the controller (20) may also display, for each exercise, the calorie consumed in response to a user exercise received from the wearable device (1) (3A), and may also display a total consumed calorie (3B), and may also display calorie consumed for each time (3C).

Meantime, a user may input a target consumable calorie to be consumed for a day through the user input part (22). Alternatively, the controller (20) may also determine a target consumable calorie to be consumed for a day in response to a user weight and an exercise amount.

As a result, the controller (20) may recommend an exercise in response to a target consumable calorie, and display the recommended exercise on the display part (23).

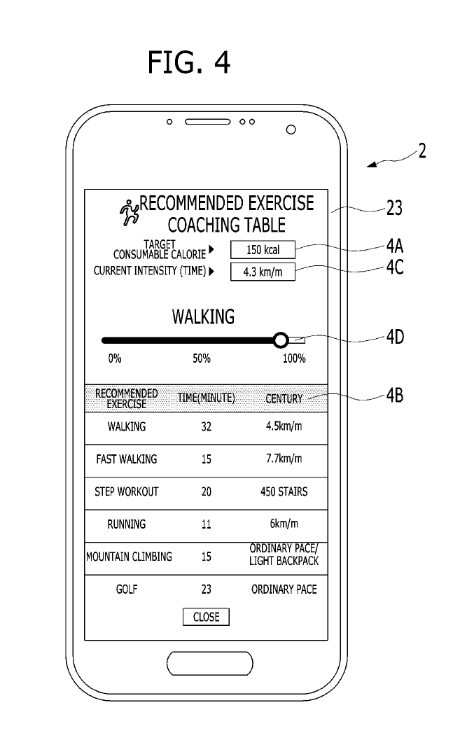

FIG. 4 is an exemplary view in which a controller (2) displays a recommended exercise in response to a target consumable calorie of a user.

Referring to FIG. 4, the controller (20) may receive a user's target consumable calorie through the user input part (22), or may also calculate the target consumable calorie in response to a weight to be reduced. The target consumable calorie may be displayed to allow a user to ascertain as shown in FIG. 4A.

As noted above, in response to the target consumable calorie, the controller (20) may display a plurality of recommended exercises, intensity of relevant recommended exercise and time on a portion of the display part (23) (4B).

That is, as in the example of FIG. 4, an exercise must be performed for 32 minutes at 4.5 km/h in order to consume 150 Kcal by walking exercise, an exercise must be performed for 15 minutes at 7.7 km/h in order to consume 150 Kcal by fast walking exercise, a 450-step workout must be performed for 20 minutes in order to consume 150 Kcal, an exercise must be performed for 11 minutes at 6 km/h in order to consume 150 Kcal by running exercise, a mountain climbing exercise must be performed with a light-weighted backpack on for 15 minutes at an ordinary pace in order to consume 150 Kcal, and an ordinary pace walking must be performed for 23 minutes in order to consume 150 Kcal by golfing exercise, these exercises of which may be displayed on the display part (23) through the controller (20). However, these are merely exemplary, and more multifarious exercises, intensity and time may be recommended.

Furthermore, the controller (20) may provide a recommendable exercise in order to consume a target consumable calorie, allow the display part to display a current exercise intensity using an exercise data received from the wearable device (1), and allow displaying what percentage degree of exercise is being exercised so that a user can read.

That is, a user can learn, from the example illustrated in FIG. 4, that he or she currently performs a walking exercise at a 4.3 km/h-speed (4C), and the controller (20) may allow displaying, in a bar shape (4D), at what ratio of degree a user performs an exercise in the recommended exercise (4B) in response to the intensity of relevant exercise.

However, these are merely exemplary, and the controller (20) does not allow displaying by being restricted thereto. That is, for example, the controller (20) may also display by determining a time in which a user must exercise in order to consume a target consumable calorie when the user exercises at a current exercise intensity, or may display in real time a calorie consumed by a current exercise along with a target consumable calorie.

As discussed from the foregoing, the controller (20) may receive the type of exercise recognized from the wearable device (1), calculate the consumed calorie, and display the consumed calorie to a user, and may recommend an exercise, intensity and time in order to consume a target consumable calorie. Furthermore, the controller (20) may display a ratio of a recommended intensity against a current intensity in order to reach a target consumable calorie using the current exercise, and may also display a time to be performed in order to consume a target consumable calorie using the current exercise.

As noted from the foregoing, the controller (20) may automatically and continuously receive an exercise data of a user from the wearable device (1) to manage the health of the user by controlling a consumed calorie of the user, and proactively provide a measure against obesity by providing a calorie to be consumed by the user, and recommending types of exercises in order to consume the calorie.

Although the present disclosure has been described with reference to a number of illustrative embodiments thereof, it should be understood that numerous other modifications and embodiments can be devised by those skilled in the art that will fall within the spirit and scope of the principles of this disclosure.

What is claimed is:

1. A method for controlling mobile terminal communicating wearable device worn at a predetermined place of a body of a user, the method comprising:
determining a target consumable calorie by receiving an input of a target consumable calorie to be consumed by a user or by receiving an input relative to a body weight to be reduced;
displaying a plurality of types of exercises, a recommendable intensity performed by each exercise and a recommendable time in performing each exercise in response to the target consumable calorie;
displaying type and intensity of exercise currently performed by the user by receiving in real time an exercise type data of the user recognized continuously by the wearable device while the user wears the wearable device; and
displaying a ratio of the intensity of exercise currently performed by the user to the recommendable intensity of the exercise to, and a time required to consume the target consumable calorie with the intensity of exercise currently performed by the user.

2. The method of claim 1, wherein the displaying type and intensity of exercise step further includes displaying a calorie consumed by the exercise currently performed by the user, along with the target consumable calorie.

3. An apparatus for controlling mobile terminal communicating wearable device, the apparatus comprising:
a display part; and
a controller configured to:
determine a target consumable calorie by receiving an input of a target consumable calorie to be consumed by a user or by receiving an input relative to a body weight to be reduced,
display, on the display part, a plurality of types of exercises, a recommendable intensity performed by each exercise and a recommendable time in performing each exercise in response to the target consumable calorie,
display, on the display part, type and intensity of exercise currently performed by the user by receiving in real time an exercise type data of the user recognized continuously by the wearable device while the user wears the wearable device, and
display, on the display part, a ratio of the intensity of exercise currently performed by the user to the recommendable intensity of the exercise to, and a time required to consume the target consumable calorie with the intensity of exercise currently performed by the user.

4. The apparatus of claim 3, wherein the controller further displays, on the display part, a calorie consumed by the exercise currently performed by the user, along with the target consumable calorie.
